(19) United States
(12) Patent Application Publication
(10) Pub. No.: US 2025/0127324 A1
(43) Pub. Date: Apr. 24, 2025

(54) BEVERAGE PREPARATION MACHINE AND METHOD FOR PREPARING A BEVERAGE PRODUCT USING SUCH A BEVERAGE PREPARATION MACHINE

(71) Applicant: SOCIETE DES PRODUITS NESTLE S.A., Vevey (CH)

(72) Inventors: ALEXANDRE PUGLIESE, Paudex (CH); XAVIER RICHI, Morges (CH); LUCIO SCORRANO, Yverdon-les-Bains (CH); ALEXANDRE PERENTES, Sullens (CH)

(21) Appl. No.: 18/572,583

(22) PCT Filed: Jun. 27, 2022
(86) PCT No.: PCT/EP2022/067476

§ 371 Date: Dec. 20, 2023

(30) Foreign Application Priority Data
Jul. 1, 2021 (EP) 21183059.1

(51) Int. Cl. A47J 31/36; A47J 31/06; A47J 31/46; A47J 31/60; B65D 85/804

(52) U.S. Cl. CPC A47J 31/3695; A47J 31/0673; A47J 31/461; A47J 31/60; B65D 85/8043

(57) ABSTRACT

The present invention is directed to a beverage preparation machine comprising:
a chamber for receiving a capsule carrying a beverage component,
a beverage preparation device having:
   a delivery device for delivering a fluid to the chamber,
   a first and a second injection element selectively fluidly connectable to the delivery device for injecting a fluid into the chamber,
   a discharge device having a discharge element for discharging the delivered fluid out of the chamber,

The first injection element protrudes farther into the chamber than the second injection element. The first injection element protrudes farther into the chamber than the discharge element. A region at which the second injection element protrudes into the chamber is located higher than a region at which the discharge element protrudes into the chamber.

### CROSS REFERENCE TO RELATED APPLICATIONS

The present application is a National Stage of International Application No. PCT/EP2022/067476, filed on Jun. 27, 2022, which claims priority to European Patent Application No. 21183059.1, filed on Jul. 1, 2021, the entire contents of which are being incorporated herein by reference.

### 1. FIELD OF THE INVENTION

The present invention is directed to a beverage preparation machine for preparing a beverage product like coffee, tea, soup etc. The present invention is also directed to a method for preparing a beverage product using such a beverage preparation machine.

### 2. TECHNICAL BACKGROUND

A known beverage preparation machine can have i) an injector for delivering a liquid into a capsule inserted in a brewing chamber and ii) a discharge element, for example in the form of a needle, for discharging the resulting beverage product out of the capsule.

However, after being discharged out of a first capsule, traces of beverage product can remain on and around the discharge element. Then, these traces of beverage product can mix with the beverage product that gets prepared with the subsequent capsule and thus alter the properties of the beverage product, say its taste or color, especially when the subsequent capsule is different from the first capsule.

Furthermore, some beverage product may remain in the used capsule and leak out of the capsule when the user is taking the capsule out of the beverage preparation device, thereby possibly causing trouble to the user.

### 3. SUMMARY OF THE INVENTION

It is thus an object of the present invention to provide a beverage preparation machine and a method, which makes it possible to prepare successive beverage products while mitigating or avoiding the issue of mixing traces of two beverage products subsequently prepared in the beverage preparation machine.

According to an aspect, the present invention is directed to a beverage preparation machine comprising:
a chamber for receiving a capsule carrying a beverage component,
a beverage preparation device having:
   a delivery device for delivering a fluid to the chamber,
   a first injection element and a second injection element, the first and second injection elements being selectively fluidly connectable to the liquid delivery device for injecting a liquid into the chamber, respectively,
   a discharge device having a discharge element for discharging the delivered fluid out of the chamber,
      wherein the first injection element protrudes farther into the chamber than the second injection element and the first injection element protrudes farther into the chamber than the discharge element, and
      wherein a region at which the second injection element protrudes into the chamber is located higher than a region at which the discharge element protrudes into the chamber.

Thus, an outlet of the second injection element may be located higher than the discharge element. So, when the second injection element dispenses a rinsing liquid, for example water, the rinsing liquid may flow on and/or around the discharge element, in particular after or at the end of the preparation of a preceding beverage product and before the preparation of a subsequent beverage product. The rinsing liquid may thus remove totally or partially the traces of the preceding beverage product from on and/or around the discharge element, and then the rinsing liquid may be evacuated out of a brewing chamber via the discharge element and the liquid discharge device.

Also, since all the delivered fluid and rinsing fluid may get evacuated from the capsule, the beverage preparation machine allows limiting or avoiding that the biodegradable capsule as the case may be degraded too quickly and already in a bin inside the machine. Further, this helps reducing the environmental impact as the energy returned will be higher, since no water remains inside the capsule.

Additionally, the beverage preparation machine thus ensures that all of the beverage component is actually delivered from the capsule to the user, which is preferable for some specific products.

In the present application, the term “higher than” and its derivatives like “upper”, “uppermost”, “lower”, “lowermost” may refer to a difference in altitude measured when the beverage preparation machine stands in its service configuration or its operational orientation, hence ready to receive a capsule and prepare a beverage product. When the beverage preparation machine is in such a configuration or orientation, the expression “a region at which the second injection element protrudes into the chamber is located higher than a region at which the discharge element protrudes into the chamber” may imply that the rinsing liquid dispensed by the second injection element flows towards the discharge element under the action of gravity.

In some embodiments, the second injection element may be configured to jet or spray the rinsing liquid towards the discharge element. Therefore, the second injection element or its outlet opening may be configured such that liquid injected into the chamber via the outlet opening of the second injection element can be jetted or sprayed onto the discharge element. Thus, the discharge element may be cleansed with a high efficiency, since jets of rinsing liquid that are jetted or sprayed by the second injection element may rinse surfaces located on and/or around the discharge element.

In the present application, the term “capsule” may refer to any receptacle enclosing a beverage ingredient in a dry, liquid, solid e.g. powdery, pasty and/or other form. For example, a capsule may have rigid or soft body and/or membrane. The body and membrane (envelope) may be generally made of a same material or of different materials. The body and membrane (envelope) may generally have the same shape or different shapes. The capsule may be hermetically sealed or be partially or totally porous. The term “capsule” may also correspond to single serve container, pod or sachet.

In the present application, the term “beverage product” may refer to a drinkable liquid or to an edible or comestible liquid, for example a soup. In the present application, the term “beverage preparation” and its derivatives may refer to any kind of interaction between a liquid and the product contained in the capsule, for example mixing, dissolving, infusing or extracting with or without the pressure of a fluid like water or steam.

According to an embodiment, the second injection element may comprise an outlet opening which is directed towards the discharge element.

According to an embodiment, a region at which the first injection element may protrude into the chamber is located higher than the region at which the discharge element protrudes into the chamber, preferably at the same height at which the second injection element protrudes into the chamber.

Thus, during the preparation of a beverage product, the first injection element does not receive any or much traces of the beverage product that flows towards and through the discharge element. In other words, the traces of the beverage product occur mostly on and/or around the discharge element.

According to an embodiment, the second injection element and, preferably, the first injection element may protrude into the chamber at an upper or uppermost region thereof, and/or wherein the discharge element may protrude into the chamber at a lower or lowermost region thereof.

Thus, this arrangement of the second injection element and, preferably, of the first injection element may minimize or even avoid the traces of the beverage product on and/or around the second injection element and, possibly, the first injection element.

According to an embodiment, the first injection element, the second injection element and the discharge element may all protrude from the same side of the beverage preparation device into the chamber.

Thus, this arrangement of the first injection element, second injection element and discharge element may help simplifying the design of the beverage preparation machine, in particular of its brewing chamber.

According to an embodiment, the beverage preparation machine may further comprise a capsule holder for holding the capsule, the capsule holder preferably being movable relative to the beverage preparation device and/or selectively connectable to the beverage preparation device so as to define the chamber.

Thus, the capsule holder may contribute in receiving and holding the capsule in the right place in the chamber. In some embodiments, the capsule holder may be selectively movable relative to the beverage preparation device between:
i) a receiving configuration in which the capsule holder is distant from the beverage preparation device such that the chamber is open to receive at least one capsule, and
ii) a connection configuration in which the capsule holder is close to the beverage preparation device so as to narrow or close the chamber.

Alternatively to a removable capsule holder which may be removed from the beverage preparation machine, the beverage preparation machine may include irremovable parts defining a brewing chamber for receiving and handling capsules.

According to an embodiment, the delivery device may comprise a liquid delivery device for delivering a liquid to the chamber, wherein, preferably, the liquid delivery device is fluidly connectable selectively to the first injection element and to the second injection element via conduits, and

wherein, preferably, valves may be provided, preferably in the conduits, to selectively deliver the liquid to at least one of the first injection element and the second injection element.

Thus, the first injection element and/or the second injection element may supply liquid into the chamber, for example a rinsing liquid or a drinkable liquid for interacting with the beverage component.

According to an embodiment, the delivery device may further comprise a gas delivery device for delivering a gas, like air, to the chamber, the gas delivery device being fluidly connectable selectively to the first injection element and to the second injection element, preferably via conduits,

wherein, preferably, valves may be provided, preferably in the conduits, to selectively deliver the gas to at least one of the first injection element and the second injection element.

Thus, the first injection element and/or the second injection element may inject the gas into the chamber in order to help evacuating the beverage product and/or the rinsing liquid out of the capsule and the chamber. The delivered gas may be used to make an emulsion in the beverage product.

In some embodiments, the gas delivery device may be configured to deliver at least one gas selected in the group comprising compressed air, CO₂ (carbon dioxide), N₂ (nitrogen), provided the gas is food grade, steam.

According to an embodiment, the valves may comprise:
a first valve for selectively connecting the first injection element either to the gas delivery device or to the liquid delivery device, and
a second valve for selectively connecting the second injection element either to the gas delivery device or to the liquid delivery device.

Thus, the first and second valve may be common to the circuit that delivers gas and to the circuit that delivers liquid. This arrangement may help simplifying the design of the beverage preparation machine.

According to a further aspect, the present invention is directed to a method, for preparing a beverage, comprising:
providing a beverage preparation machine disclosed herein,
providing a capsule carrying a beverage component, the capsule having i) a body defining a cavity, the cavity having an opening, ii) a membrane attached to the body so as to cover the opening and close the cavity, the body including i) a beverage space containing a beverage component, ii) a head space extending between the beverage space and the membrane, and iii) a partition element separating the beverage space from the head space, the partition element preferably comprising a filter element,
receiving the capsule in the chamber,
inserting the first injection element through the membrane and into the beverage space,
inserting the second injection element through the membrane and into the head space,
inserting the discharge element through the membrane and into the head space,
delivering a fluid, preferably at least a liquid, into the beverage space via the first injection element such that the delivered liquid may interact with the beverage component in order to prepare a beverage product,
discharging the beverage product out of the capsule via the discharge element, and
after having discharged the beverage product, injecting a fluid, preferably at least liquid and/or steam, into the head space via the second injection element so as to rinse the discharge element.

Thus, when the second injection element dispenses a rinsing liquid, for example water, the rinsing liquid may flow on and/or around the discharge element, in particular after or at the end of the preparation of a preceding beverage product and before the preparation of a subsequent beverage product.

In case the fluid is or comprises steam, the steam might condense after a certain time and then allow the delivery of the beverage product. Steam may be used to thermally treat the capsule before extraction of a beverage product, for example to sterilize the beverage component or to preliminarily heat up the beverage component, in particular in a pre-wetting phase.

According to an embodiment, after having discharged the beverage product, the step of injecting a fluid into the head space via the second injection element comprises injecting a fluid into the head space via the second injection element so as to jet or spray the injected fluid on and/or around the discharge element, preferably at least on a discharge opening of the discharge element.

Thus, the rinsing fluid may remove totally or partially the traces of the preceding beverage product from on and/or around the discharge element, and then the rinsing fluid may be evacuated out of a brewing chamber via the discharge element and the discharge device.

According to an embodiment, the method may further comprise: injecting a gas into the head space via the second injection element i) during the delivery of fluid, preferably liquid, into the beverage space via the first injection element, and/or ii) during the discharging of the beverage product via the discharge element.

Thus, the injected gas may prevent or mitigate the beverage product from spreading into the head space, which enhances the cleanliness thereof.

According to an embodiment, delivering fluid, preferably liquid, into the beverage space via the first injection element may comprise, before producing the beverage product, pre-wetting the beverage component and, optionally, evacuating gas from the capsule via at least one of the second injection element and the discharge element.

Thus, pre-wetting the beverage component may contribute to enhance some properties of the beverage product. The steam could be used for the pre-wetting or else for the rinsing.

According to an embodiment, the method may further comprise: injecting gas into the beverage space i) after injecting fluid, preferably liquid, into the beverage space and ii) at least partially simultaneously during discharging the beverage product and/or iii) at least partially during delivery of fluid, preferably liquid and/or steam, into the head space.

Thus, the injected gas may help evacuating the beverage product out of the beverage space and into the discharge element.

According to an embodiment, the method may further comprise injecting gas into the head space via the second injection element after injecting fluid, preferably liquid and/or steam, into the head space.

Thus, the injected gas may help evacuating the beverage product out of the head space and into the discharge element.

This rinsing and flushing of the capsule (by taking out the remaining water) avoid maceration and preliminary composting of the capsule inside the beverage preparation machine's bin and will additionally improve the level of energy that is released during degradation of the capsule.

In some embodiments, the discharged beverage product may be delivered to a dispensing unit, which is arranged downstream the discharge element, and which is configured to dispense the beverage product. Thus, the dispensing unit may dispense the beverage product out further downstream, preferably into a user's cup.

### 4. BRIEF DESCRIPTION OF DRAWINGS

Further features, details and advantages of the present invention will now be described in relation to the embodiments of the enclosed figures.

FIG. 1 shows a schematic outer view, along arrow I in FIG. 2, of a part of a beverage preparation machine according to an embodiment including a capsule holder.

FIG. 2 shows a schematic half cut-out perspective side view as cut along line II-II in FIG. 1, with a capsule suitable therefor.

FIG. 3 shows a schematic half cut-out perspective side view as cut along line III-III in FIG. 1, with the capsule.

FIG. 4 shows a schematic half cut-out perspective side view as cut along line IV-IV in FIG. 1, with the capsule.

FIG. 5 shows the detail V in FIG. 3 on a larger scale.

FIG. 6 shows a schematic perspective view of the capsule holder of FIG. 1 with the capsule.

FIG. 7 shows a schematic, enlarged cross-section, approximately along line VII-VII in FIG. 4, of a chamber of the beverage preparation machine of FIGS. 1-6 with the capsule of FIGS. 7-8.

FIG. 8 shows a schematic exploded perspective view of the capsule as shown in FIGS. 1-5.

FIG. 9 shows a schematic perspective view of the capsule of FIG. 8 without its membrane.

FIG. 10 shows a flow diagram illustrating a method according to an embodiment.

FIG. 11 shows a schematic view of a fluidic diagram of a part of the beverage preparation machine of FIGS. 1-7 with the capsule, in a standby state where no liquid or gas may flow.

FIG. 12 shows a view similar to FIG. 11 in a state where liquid may flow.

FIG. 13 shows a view similar to FIG. 11 in a state where gas may flow.

FIG. 14 shows a view similar to FIG. 11 in a state where the beverage component may be pre-wetted.

FIG. 15 shows a view similar to FIG. 11 in an infusion state where liquid may interact with the beverage component, without any liquid or gas flowing.

FIG. 16 shows a view similar to FIG. 11 in a state where gas may flush the beverage product out of the capsule.

FIG. 17 shows a view similar to FIG. 11 in a state where liquid may be rinsing some parts stained by the beverage product.

FIG. 18 shows a view similar to FIG. 11 in a state combining the functions shown in FIGS. 16 and 17.

FIG. 19 shows a schematic cross-section of the capsule of FIG. 6, with a detailed liquid flow.

FIG. 20 shows a view similar to FIG. 11 in a state simultaneously fulfilling the functions shown in FIGS. 12 and 13.

FIG. 21 shows a view similar to FIG. 19, with detailed liquid and gas flows.

### 5. DETAILED DESCRIPTION

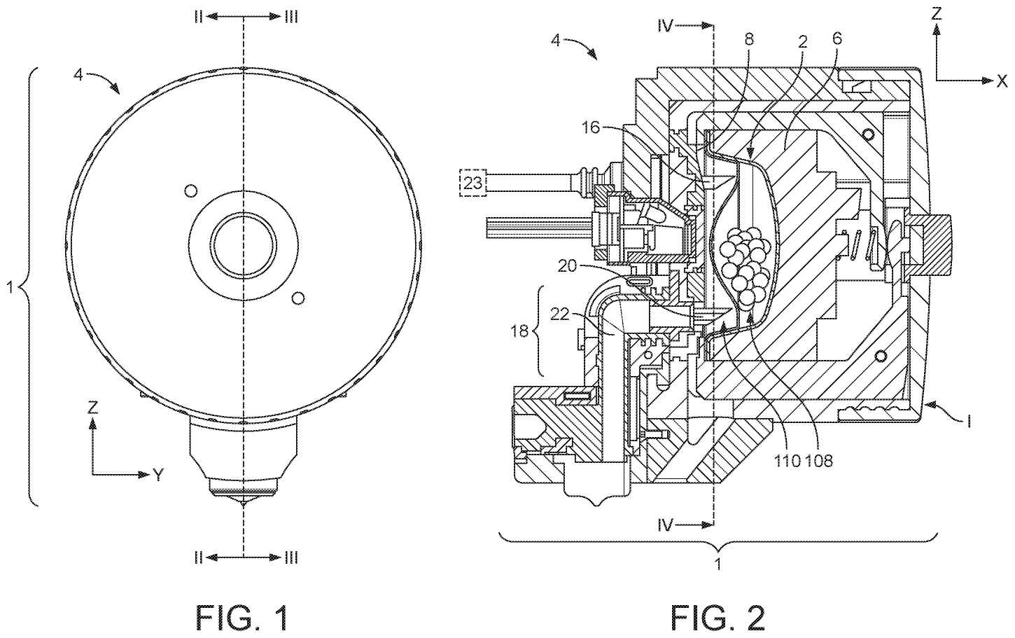

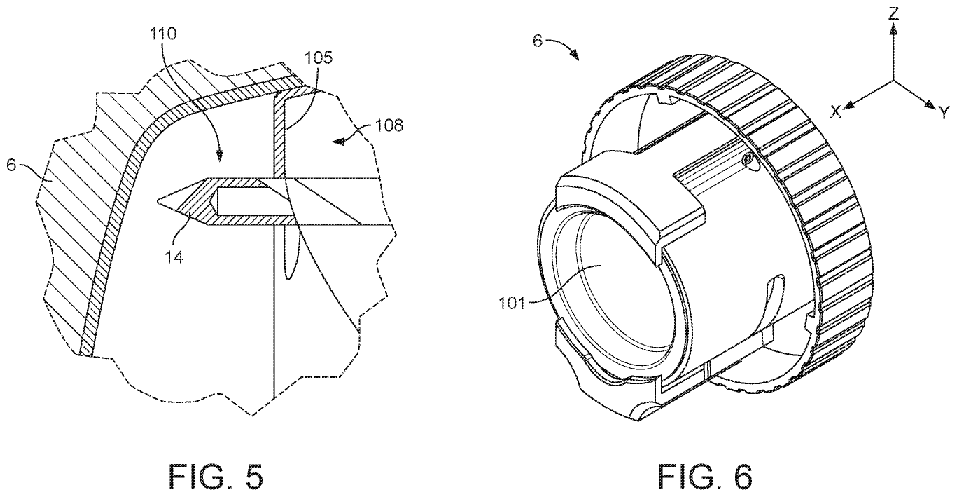

FIGS. 1 to 6 show an embodiment of a beverage preparation machine 1 for preparing a beverage product, as well as particular details and parts thereof. FIGS. 1 to 6 show a beverage preparation machine 1 comprising a chamber 2 and a beverage preparation device 4.

The chamber 2 is configured to receive a capsule 101 carrying a beverage component 102. The chamber 2 may be formed between a capsule holder 6 and a cover 8 of the beverage preparation machine 1. The chamber 2 may have a volume shaped like the capsule 101.

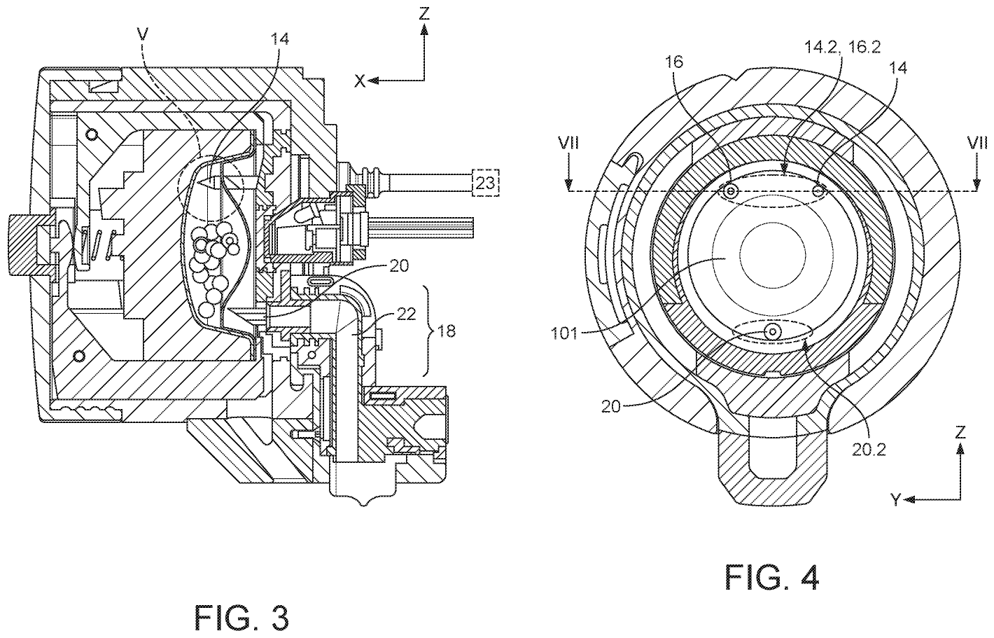

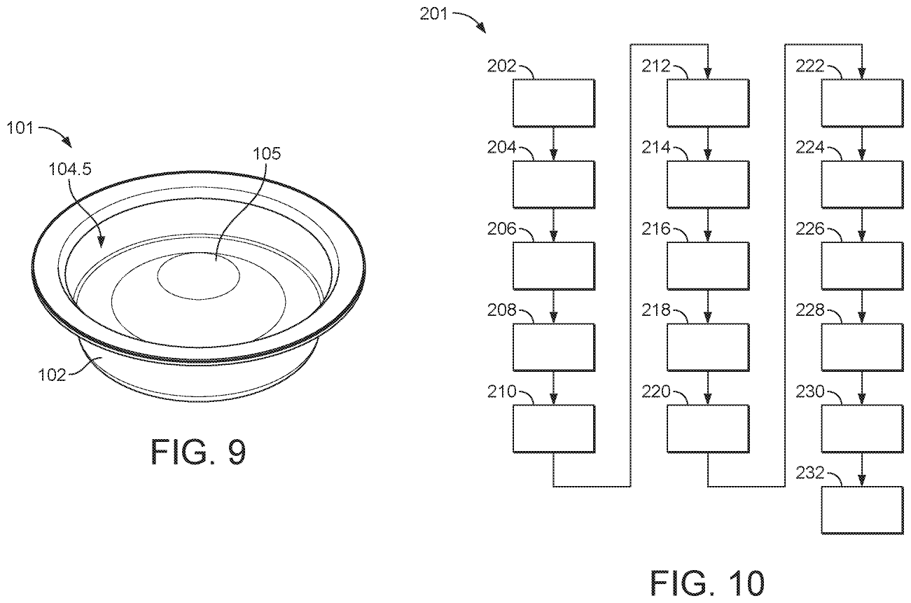

The capsule 101, as visible in FIGS. 2 and 3 and as detailed in FIGS. 8 and 9, may have a body 104 and a membrane 106. The membrane 106 may be attached, directly or indirectly, to the body 104. The membrane 106 may generally have a circular shape. The membrane 106 may be relatively flexible and comprise a laminate of including plastic foils and/or aluminum foils.

The body 104 may define a cavity 104.0 and generally have a frustoconical shape. The body 104 may have a side wall 104.1, an end wall 104.2 and an annular rim 104.4 around an opening 104.5 at one side of the cavity 104.0. The side wall 104.1 may be integral with the end wall 104.2, for example one-piece. The membrane 106 may be glued or welded onto the annular rim 104.4. The body 104 may be relatively rigid. The body 104 may be made out of aluminum. Body 104 may also be made of bio-based plastic or fiber-based material. Preferably, the material of the body 104 will be recyclable, compostable and/or biodegradable.

Further, the body 104 may include a partition component 105 configured to divide the cavity 104.0 into:
i) a beverage space 108, which contains the beverage component 102, for example a coffee powder, and
ii) a head space no extending between beverage space 108 and membrane 106.

The partition element 105 may separate the beverage space 108 from the head space no. The partition element 105 preferably comprises a filter element.

In the illustrated example, the partition component 105 may be flat or slightly bulged in a central region thereof. The partition component 105 may comprise a filter element and be formed of woven or non-woven material, e.g. PA, PET, PP, paper, etc.

Exemplary shape and size: The capsule 101 may have a generally circular shape, with a largest diameter of about 50-55 mm. The beverage space 108 may have a height of about 9 mm and the head space may have a height of about 7.5 mm, which can be measured parallel to the axis of symmetry of the capsule 101.

The capsule holder 6 may be configured to hold the capsule 101, in particular its body 104, so that the capsule 101 is received in the right place in the chamber 2. The capsule holder 6 may be selectively connectable to the beverage preparation device 4 so as to define the chamber 2. In the embodiment of FIGS. 1 to 6, the capsule holder 6 may be selectively movable in translation along axis X relative to the cover 8 and the beverage preparation device 4. The capsule holder 6 may thus be moved between:
i) a receiving configuration (not shown) in which the capsule holder 6 is distant from the beverage preparation device 4 and the cover 8, such that the chamber 2 is open to receive a capsule 101, and
ii) a connection configuration (FIGS. 1-6) in which the capsule holder 6 is close to, here even in contact with, the beverage preparation device 4 and the cover 8 so as to close the chamber 2 and prepare a beverage product.

The beverage preparation machine 1 may further comprise a not-shown insertion conduct configured to allow a capsule 101 to be inserted in the chamber 2. The inserted capsule 1 may reach the chamber 2 under the action of gravity.

Besides, the beverage preparation device 4 has a delivery device 23, a first injection element 14, a second injection element 16 and a discharge device 18.

The delivery device 23 is configured for delivering at least one fluid to the chamber 2. The fluid may for example be hot water, chilled water, steam, milk (e.g. dairy or plant-based milk), coffee and so on. In the embodiment of FIGS. 1-6 the liquid may be hot water or steam, at a temperature of between 1° C. and 120° C. (steam), preferably between 40° C. and 100° C. The fluid may be suitable to interact with the beverage component 102 in the capsule 101 so as to produce a beverage product. An example of operating the beverage preparation machine 1 and in particular the delivery device 23 is described in detail below in relation to fluidic diagrams of FIGS. 12 to 21.

The first injection element 14 is selectively fluidly connectable to the delivery device 23 for injecting the fluid into the chamber 2. Similarly, the second injection element 16 is selectively fluidly connectable to the delivery device 23 for injecting the fluid into the chamber 2.

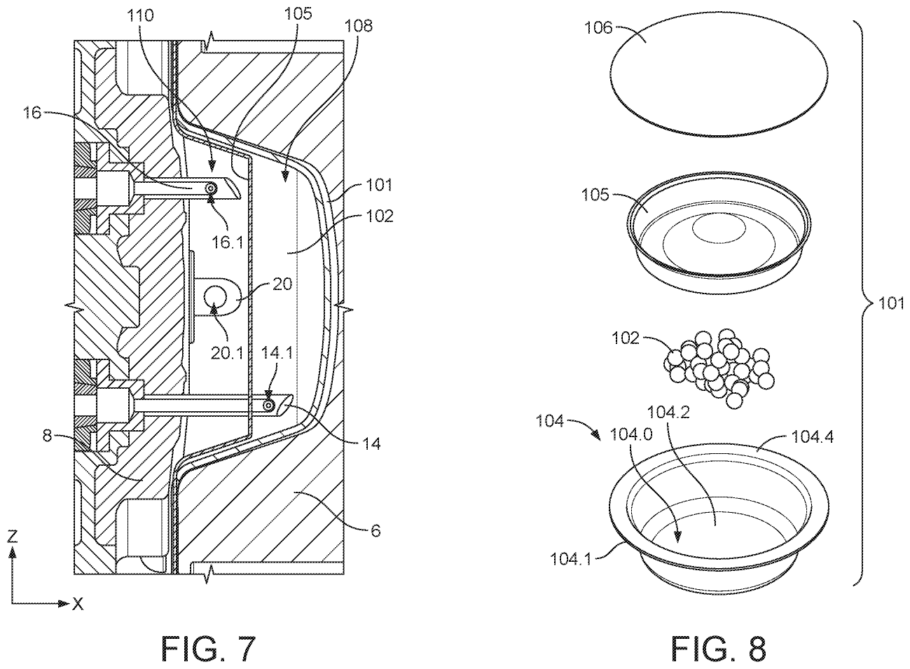

As visible in particular in FIG. 7, the first injection element 14 and the second injection element 16 may substantially have a rectilinear shape. The first injection element 14 and the second injection element 16 may include respective hollow needles or canulae. The needles of the first and second injection elements 14 and 16 may for example be about 11 mm long and 7 mm long, respectively, and both have an inner diameter of about 1 mm. The cantilever ends of the needles of the first and second injection elements 14 and 16 may for example have bevel angles of about 30 degrees and −30 degrees, respectively, which helps in piercing the membrane 106 and the partition component 105.

As visible in FIG. 7, the first injection element 14 may comprise an outlet opening 14.1 which is directed towards the beverage component 102 located inside the beverage space 108 of the capsule 101 for delivering hot water (for example) to the beverage component 102. The second injection element 16 may comprise an outlet opening 16.1, which is directed towards the discharge element 20. The second injection element 16 may be configured to jet or spray a rinsing fluid towards the discharge element 20. Therefore, the second injection element 16 or its outlet opening 16.1 may be configured such that fluid injected into the chamber 2 via the second injection element 16 (i.e. via its outlet opening 16.1) can be jetted or sprayed onto the discharge element 20.

The discharge device 18 has a discharge element 20 for discharging the delivered fluid out of the chamber 2. The discharge element 20 may substantially have a rectilinear shape. The discharge element 20 may include a hollow needle or cannula, which may for example be 7 mm long and have an inner diameter of about 2.5 mm. The cantilever end of the needle of the discharge element 20 may for example have a bevel angle of about 170 degrees to enhance a proper fluid drainage by gravity. Further, the discharge device 18 may have a discharge conduct 22, which may be arranged downstream the discharge element 20 and conduct the discharged beverage product toward a not-shown receptacle like a user's cup 51.

A horizontal and longitudinal arrangement of the first 14 and second 16 injection elements and the discharge element 20 relative to the chamber 2 is shown on a larger scale in FIG. 7. In FIGS. 1 to 7, an axis X represents a horizontal and longitudinal direction, an axis Y represents a horizontal and transversal direction, and an axis Z represents a vertical direction oriented upward (opposite the gravity) when the beverage preparation machine 1 is in its service configuration or operational orientation.

The first injection element 14 protrudes farther into the chamber 2 than the second injection element 16. This can be measured along longitudinal direction X. The first injection element 14 also protrudes farther into the chamber 2 than the discharge element 20. This can be measured along longitudinal direction X.

The first injection element 14, the second injection element 16 and the discharge element 20 may all protrude into the chamber 2 from the same side of the beverage preparation device 4, i.e., the right side in FIG. 3.

FIGS. 2 to 4 show a vertical arrangement of the first 14 and second 16 injection elements and the discharge element 20 relative to the chamber 2. As shown in particular in FIG. 4, region 16.2 at which the second injection element 16 protrudes into the chamber 2 is located higher than a region 20.2 at which the discharge element 20 protrudes into the chamber 2. This can be measured along vertical direction Z.

Similarly, a region 14.2 at which the first injection 14 element protrudes into the chamber 2 may be located higher than the region 20.2 at which the discharge element 20 protrudes into the chamber 2. Preferably, the second injection element 16 and the first injection element 14 may protrude in the chamber 2 substantially at the same height.

In the embodiment of FIGS. 1 to 6, the second injection element 16 and the first injection element 14 may protrude into the chamber 2 at an upper region thereof, i.e., in regions 16.2 and 14.2 in FIG. 4. The discharge element 20 may protrude into the chamber 2 at the lowermost region thereof, i.e., region 20.2 in FIG. 4.

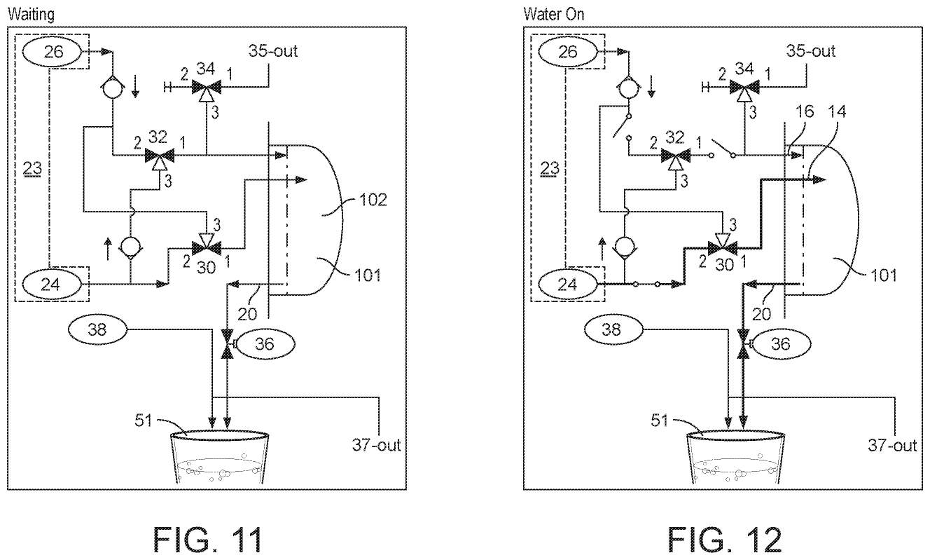

FIGS. 11 to 18 and 20 show fluidic diagrams illustrating the hydraulic and/or pneumatic circuits of one particular embodiment. However, the beverage preparation machine and method according to the invention are not limited to these fluidic diagrams as they may be implemented with various configurations or fluidic diagrams.

As shown in the fluidic diagrams of FIGS. 11 to 18 and 20, the delivery device 23 may comprise a liquid delivery device 24 (FIG. 3) and a gas delivery device 26 (FIG. 2). The liquid delivery device 24 may include a pump or booster pump unit (BPU) to deliver a liquid, for example water, which helps prepare beverage products. The gas delivery device 26 may include a pump or booster pump unit (BPU) to deliver a gas, for example air, which helps prepare beverage products, cleaning and/or rinsing the capsule.

The liquid delivery device 24 may be fluidly connectable selectively to the first injection element 14 and to the second injection element 16 via the conduits shown in FIG. 11. Similarly, the gas delivery device 26 may be fluidly connectable selectively to the first injection element 14 and to the second injection element 16 via the conduits shown in FIG. 11.

To make these hydraulic and pneumatic connections, the beverage preparation device 4 may further comprise conduits and valves as shown in FIG. 11. The valves are respectively provided in the conduits so as to selectively deliver the liquid and/or the gas to the first injection element 14 and/or to the second injection element 16. The valves may comprise:
a first valve 30 configured to selectively connect the first injection element 14 to the delivery device 23, thus either to the gas delivery device 26 or to the liquid delivery device 24,
a second valve 32 configured to selectively connect the second injection element 16 to the delivery device 23, thus either to the gas delivery device 26 or to the liquid delivery device 24,
a third valve 34 configured to selectively connect the second injection element 16 to a gas exhaust port 35-out, and
a fourth valve 36 configured to selectively connect the discharge element 20 to either a dispense conduit or to a liquid exhaust port 37-out.

In the example of FIGS. 11 to 18 and 20, the first, second, third and fourth valves 30, 32, 34, 36 may be formed by three-way valves. Nevertheless, depending on the design of the fluidic diagram, the first, second, third and fourth valves 30, 32, 34, 36 may have one or more inlet ports and one or more outlet ports, as well as motors for selectively connecting said inlet and outlet ports.

The individual arrangements of the conduits and valves is accurately depicted in FIGS. 11 to 18 and 20, SO it is not described herein.

FIG. 11 further shows check or non-return valves, which may be arranged in the beverage preparation device 4 so as to orient the liquid and gas flows away from the delivery device 23, hence from liquid delivery device 24 and gas delivery device 26. FIG. 11 also shows a main water source 38, which may include a pump.

An Electronic Control Unit (ECU) 40 may be included in the beverage preparation machine 1. The ECU 40 may be configured to control the opening and closing of the chamber 12, preferably by controlling the movement of the capsule holder 6 towards and away from the cover 8. The ECU 40 may further be configured to selectively control the opening and closing of the first, second, third and fourth valves 30, 32, 34, 36.

The ECU 40 may also be configured to control the delivery device 23, hence the liquid delivery device 24 and the gas delivery device 26 as the case may be, preferably for setting the pressures and/or temperatures of the liquid and of the gas respectively. In particular, the ECU 40 may receive information about a specific recipe for a given capsule and set these pressures and/or temperatures accordingly, the information being for example encoded on the capsule 101.

FIG. 10 illustrates a method 201 for preparing a beverage product. The method 201 may comprise the following steps:
In a first step 202, the beverage preparation machine 1 is provided.
In a second step 204, the capsule 101 is provided, for example by a user.
In a third step 206, the capsule 101 is inserted in the capsule holder 6 and/or in the not shown insertion conduit, and then the capsule 101 is received in the chamber 2 where it may be held by the capsule holder 6.
In a fourth step 208, the first injection element 14 is inserted through the membrane 106 and into the beverage space 108.
In a fifth step 210, the second injection element 16 is inserted through the membrane 106 and into the head space no. The fifth step 210 may occur simultaneously with the fourth step 208 when the capsule holder 6 and the cover 8 are connected with one another, i.e., when the chamber 2 is closed.
In a sixth step 212, the discharge element 20 is inserted through the membrane 106 and into the head space no. The sixth step 212 may occur simultaneously with the fourth step 208 and/or the fifth step 210 when the capsule holder 6 and the cover 8 are connected with one another, i.e., when the chamber 2 is closed.
In a seventh step 214, the fluid, say hot water and/or steam, is delivered into the beverage space 108 via the first injection element 14 such that the delivered liquid may interact with the beverage component 102 in order to prepare a beverage product. This interaction may occur by way of infusion, extraction, dissolution and the like, in order to thus prepare a beverage product like coffee, tea, soup etc.
In an eighth step 216, the beverage product is discharged out of the capsule lol via the discharge element 20. The beverage product may be channeled through the dispensing unit so as to get dispensed in the user's cup 51.
In a ninth step 218, after having discharged the beverage product, the beverage preparation device 4 may inject liquid, say water, into the head space 108 via the second injection element 16 so as to rinse the discharge element 20.
In a tenth step 220, the chamber 2 may be opened, in order to let the used capsule 101 be ejected out of the chamber 2.

After having discharged the beverage product in ninth step 218, the step of injecting 218 a fluid into the head space no via the second injection element 16 comprises injecting 218 a fluid into the head space no via the second injection element 16 so as to jet or spray the injected fluid on and/or around the discharge element 20, preferably at least on the discharge opening 20.1 FIG. 7 of the discharge element 20.

Some steps of the method 201 are shown in FIGS. 11 to 18 and 20, in which the following symbols are used:
the thin and thick lines represent conduits;
the arrows represent the direction of the fluid—liquid, steam or gas—flows may follow;
a thick line shows that fluid—liquid, steam or gas—is flowing in the conduit;
the first, second, third and fourth valves 30, 32, 34, 36 have their open ports colored in black and their closed, blocked ports colored in white.

The following tables 1 and 2 give an example of how the ECU 40 may control the beverage preparation device 4 in order to fulfil various basic functions represented in FIGS. 11 to 18 and 20, which are respectively labelled “Waiting”, “Water ON”, “Air ON”, “Pre-wetting”, “Infusion”, “Air flush”, “Water flush”, “Air/Water flush”, and “Water/Air ON”. These labels are indicated both in the first lines of the tables 1 and 2 and on FIGS. 11 to 18 and 20.

TABLE 1

| BASIC | | | | | Pre | |
|---|---|---|---|---|---|---|
| FUNCTIONS | | Waiting | Water ON | Air ON | Wetting | Infusion |
| | delay (sec) | | | | | |
| EV A - Water Valve | Inf | — | — | — | — | — |
| EV B - Air Valve | Flush | — | — | — | 1 | — |
| EV C - Exhaust | Exh | — | — | — | 1 | — |
| Valve | | | | | | |
| Motor Position | Clamp/Midd/Rins | — | Middle | Middle | Clamp | Clamp |
| Water Pump (BPU) | | — | 1 | — | 1 | — |
| Boiler Temp. | (° C.) | pre-heat | 90° C. | pre-heat | 90° C. | pre-heat |
| | | xx° C. | | xx° C. | | xx° C. |
| Air Pump | (start ramp) | — | — | 1 | — | — |
| Main Air Pump | | — | — | — | — | — |

TABLE 2

| | | | | Air/Water | Water/Air |
|---|---|---|---|---|---|
| | | Air Flush | Water Flush | Flush | ON |
| | delay (sec) | | | | |
| EV A - Water Valve | Inf | 1 | 1 | 1 | — |
| EV B - Air Valve | Flush | 1 | 1 | 1 | 1 |
| EV C - Exhaust Valve | Exh | — | — | — | 1 |
| Motor Position | Clamp/Midd/Rins | Rinsing/Middle | Rinsing/Middle | Rinsing/Middle | Rinsing/Middle |
| Water Pump (BPU) | | — | 1 | 1 | 1 |
| Boiler Temp. | (° C.) | pre-heat xx° C. | 100° C. | 100° C. | pre-heat xx° C. |
| Air Pump | (start ramp) | 1 | 1 | 1 | 1 |
| Main Air Pump | | — | — | — | — |

In the first columns of tables 1 and 2:
the term “EV A—Water Valve” designates the first valve 30;
the term “EV B—Air Valve” designates the second valve 32;
the term “EV C—Exhaust Valve” designates the third valve 34;
the term “Motor position” designates the fourth valve 36, which can be put in the following positions:
   “Clamp” indicates that the fourth valve 36 is closed,
   “Middle” indicates that the fourth valve 36 dispenses the beverage product towards the user's cup 51, and
   “Rinsing” indicates that the fourth valve 36 allows the evacuation liquid towards the liquid exhaust port 37-out;
the term “Water Pump (BPU)” designates the liquid delivery device 24;
the term “Air Pump” designates the gas delivery device 26;
the term “Boiler Temp.” designates the temperature at which the fluid, preferably liquid and/or steam, may be heated, for example 90° C., 100° C. or 120° C.;
the term “Main Water Pump” designates the main water source 38;
the number “1” indicates that fluid is flowing in or from the corresponding valve or device; and
the sign “-” indicates that no fluid flows in or from the corresponding valve or device.

The method 201 may further comprise a step 222 of injecting gas into the head space no via the second injection element 16 i) during the delivery of fluid, preferably liquid, into the beverage space 108 via the first injection element 14, and/or ii) during the discharging of the beverage product via the discharge element 20.

Step 222 of delivering fluid, preferably liquid, into the beverage space 108 may comprise a step 224 of pre-wetting by a fluid, liquid and/or steam, the beverage component 102 (FIG. 7, 8) before producing the beverage product. Further, an optional step 226 may involve evacuating gas from the capsule 101 via at least one of the second injection element 16 and the discharge element 20.

The method 201 may further comprise a step 228 of injecting gas into the beverage space 108 i) after injecting fluid, preferably liquid, into the beverage space 108 and ii) at least partially simultaneously during discharging the beverage product and/or iii) at least partially during delivery of fluid, preferably liquid, into the head space no.

The method 201 may further comprise a step 230 of injecting gas into the head space no via the second injection element 16 after injecting fluid, preferably liquid, into the head space no.

In a further step 232, the discharged beverage product may be delivered to a dispensing unit, which is arranged downstream the discharge element 20 and which is configured to dispense the beverage product, for example into a user's cup 51.

Turning to the fluidic diagrams of FIGS. 11 to 21. FIG. 11 illustrates the function of “Waiting”. The fourth, fifth and sixth steps 208, 210 and 212 have been performed, with the first and second injection elements 14 and 16 and the discharge element 20 being inserted through the membrane 106. No fluid, liquid, steam and/or gas may flow in the circuits or through the valves.

FIG. 12 illustrates the function of “Water ON”. Fluid, e.g. water, may flow from the delivery device 23, here from the liquid delivery device 24, into the beverage space 108 via the first injection element 14. The beverage component 102 may get wet and some beverage product may be discharged via the discharge element 20 and valve 36 to be then dispensed in the user's cup 51.

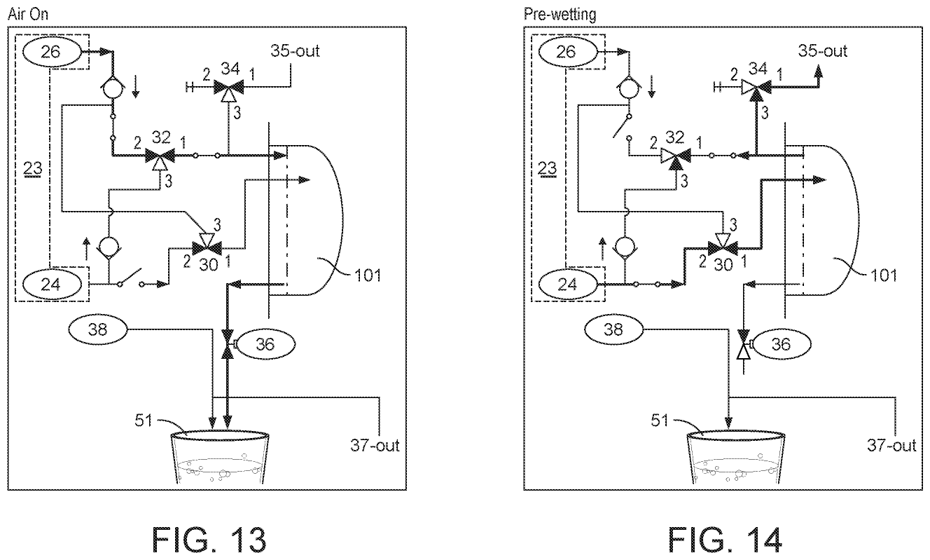

FIG. 13 illustrates the function of “Air ON”. Air may be flowing from the delivery device 23, here the gas delivery device 26 into the head space no via the second injection element 16. This allows pushing the beverage product remaining in the capsule out and some beverage product may still being discharged via the discharge element 20 and then dispensed in the user's cup 51.

In particular, the gas, e.g. air, may be delivered under a pressure selected to keep the capsule tight relative to its environment, e.g. the chamber 2. For example, in case the chamber 2 is under ambient pressure, then the air pressure may be slightly higher than the ambient pressure, hence minimal.

Thus, the capsule 101 may be kept tight, in particular around needles that form the first and second injection elements 14 and 16 and the discharge element 20, by the delivered gas as well as along by the complementary shape of a needle plate carrying these needles. After the beverage preparation, the delivered gas may be evacuated out of the capsule lol via the fourth valve 36 and the gas exhaust port 35-out. To evacuate this gas, the valves and pumps may be actuated gently in order to avoid a hammer effect that would risk impairing the tightness of the capsule 101.

FIG. 14 illustrates the function of “Pre-wetting”. Fluid, liquid and/or steam, may flow from the delivery device 23 into the beverage space 108 of capsule lol via the first injection element 14 and stay therein, as the fourth valve 36 is closed. Air may be evacuated via the second valve 34 to the gas exhaust port 35-out. The beverage component 102 may get wetted. In case the fluid is or comprises steam, the steam might condense after a certain time around beverage component 102 and then allow the delivery of the beverage product.

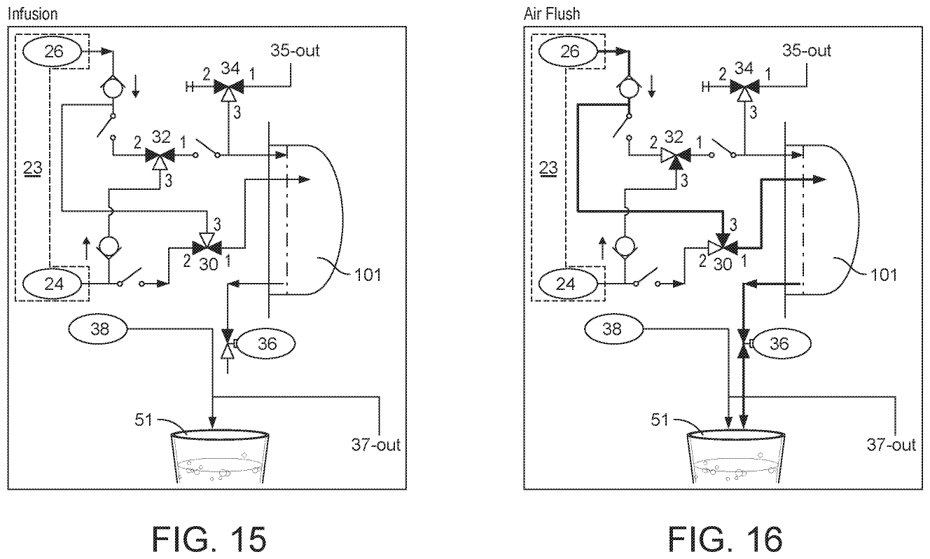

FIG. 15 illustrates the function of “Infusion”. No fluid, liquid, steam and/or gas, may flow in the circuits or through the valves as water and/or steam has already been delivered and stands in contact with the beverage component 102. The beverage component 102 may interact with the water to produce beverage product and no delivery of the beverage product is allowed.

FIG. 16 illustrates the function of “Air flush”. Air may flow from the gas delivery device 26 via the first injection element 14 to flush the beverage product out of the beverage space 108. As the fourth valve 36 is open, the beverage product may be discharged via the discharge element 20 and dispensed in the user's cup 51.

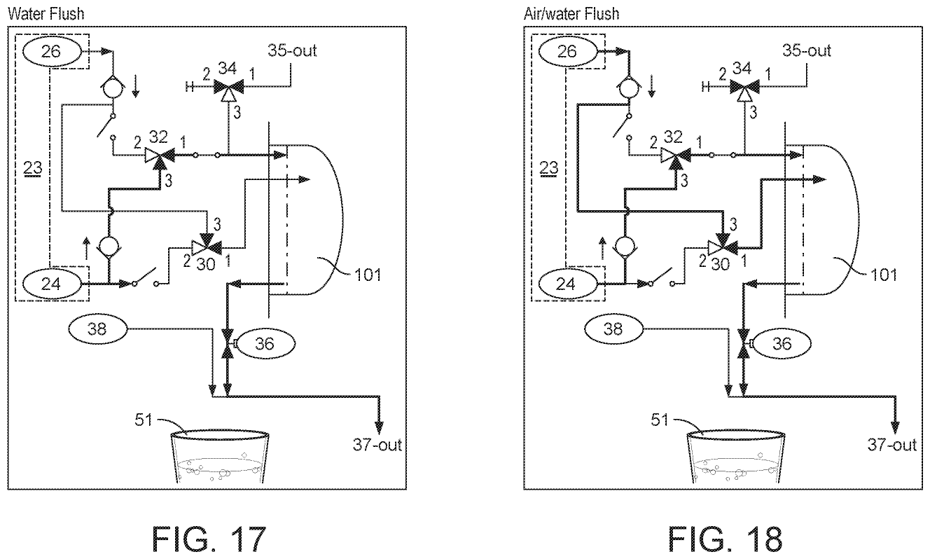

FIG. 17 illustrates the function of “Water flush”. Fluid, liquid and/or steam, may flow from the delivery device 23 via the second injection element 16 to rinse the head space no. In particular, fluid may be jetted or sprayed on and around the discharge element 20, as shown in FIG. 19 by the vertical arrow. As the fourth valve 36 is in the “Rinsing” position, the rinsing fluid, e.g. water, may be evacuated via the discharge element 20 and the liquid exhaust port 37-out. Alternatively, the rinsing fluid may be delivered as part of the beverage product when the rinsing fluid has the same characteristics as the beverage product.

FIG. 18 illustrates the function of “Air/water flush”, which combines the functions of “Air flush” and “Water flush” as afore-described in relation to FIGS. 16 and 17, except that all the fluid, e.g. liquid, may be evacuated via the discharge element 20 and the liquid exhaust port 37-out, as the fourth valve 36 is in the “Rinsing” position. In particular, water may be jetted or sprayed on and around the discharge element 20, as shown in FIG. 21 by the vertical arrow on the left, while air as shown by the arrow on the right may flush the rinsing liquid fluid, preferably liquid and/or steam, out of the capsule.

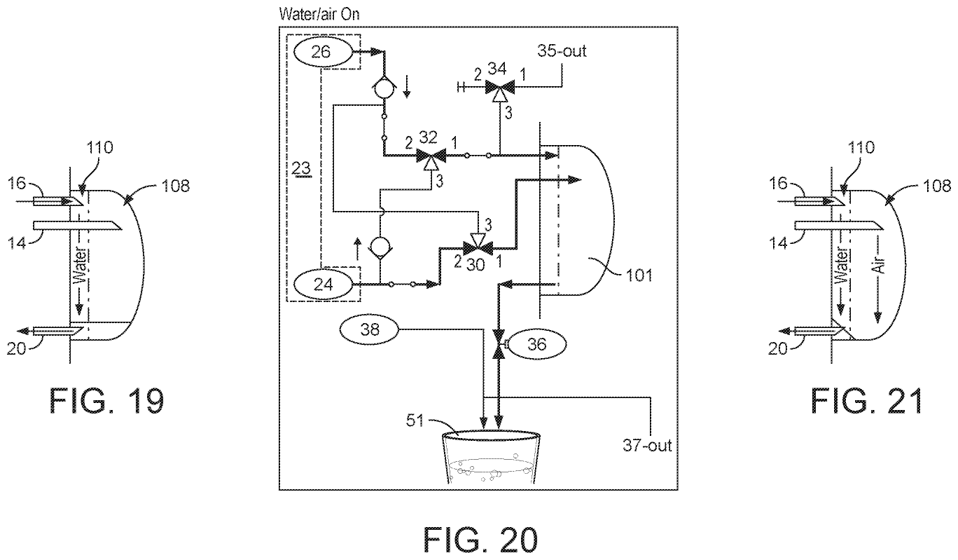

FIG. 20 illustrates the function of “Water/air ON”, which simultaneously performs the functions of “Water ON” and “Air ON” as afore-described in relation to FIGS. 12 and 13. The function of “Water/air ON” is an alternative to subsequently performing the functions of “Water ON” and “Air ON” one after the other. In particular, water may flow inside the beverage space 108 while air may push the fluid, preferably liquid and/or steam coming from the beverage space 108 trough partition element 105, out of the capsule.

The present invention is not limited to the embodiments as described herein above as long as being covered by the appended claims.

1. Beverage preparation machine comprising:
a chamber for receiving a capsule carrying a beverage component,
a beverage preparation device having:
a delivery device for delivering a fluid to the chamber,
a first injection element and a second injection element, the first and second injection elements being selectively fluidly connectable to the delivery device for injecting a fluid into the chamber, respectively,
a discharge device having a discharge element for discharging the delivered fluid out of the chamber,
the first injection element protrudes farther into the chamber than the second injection element and the first injection element protrudes farther into the chamber than the discharge element, and
a region at which the second injection element protrudes into the chamber is located higher than a region at which the discharge element protrudes into the chamber.

2. Beverage preparation machine according to claim 1, wherein the second injection element comprises an outlet opening which is directed towards the discharge element.

3. Beverage preparation machine according to claim 1, wherein a region at which the first injection element protrudes into the chamber is located higher than the region at which the discharge element protrudes into the chamber.

4. Beverage preparation machine according to claim 1, wherein the second injection element protrude(s) into the chamber at an upper or uppermost region thereof.

5. Beverage preparation machine according to claim 1, wherein the first injection element, the second injection element and the discharge element all protrude from the same side of the beverage preparation device into the chamber.

6. Beverage preparation machine according to claim 1, further comprising a capsule holder for holding the capsule.

7. Beverage preparation machine according to claim 1, wherein the delivery device comprises a liquid delivery device for delivering a liquid to the chamber, and
valves are provided to selectively deliver the liquid to at least one of the first injection element and the second injection element.

8. Beverage preparation machine according to claim 1, wherein the delivery device comprises a gas delivery device for delivering a gas to the chamber, the gas delivery device being fluidly connectable selectively to the first injection element and to the second injection element via conduits.

9. Beverage preparation machine according to claim 7, wherein the valves comprise:
a first valve for selectively connecting the first injection element either to the gas delivery device or to the liquid delivery device, and
a second valve for selectively connecting the second injection element either to the gas delivery device or to the liquid delivery device.

10. Beverage preparation machine according to claim 7, wherein the valves comprise:
a third valve configured to selectively connect the second injection element to a gas exhaust port, and
a fourth valve configured to selectively connect the discharge element to either a dispense conduit or to a liquid exhaust port.

11. Method for preparing a beverage product, comprising:
providing a beverage preparation machine comprising:
a chamber for receiving a capsule carrying a beverage component,
a beverage preparation device having:
a delivery device for delivering a fluid to the chamber,
a first injection element and a second injection element, the first and second injection elements being selectively fluidly connectable to the delivery device for injecting a fluid into the chamber, respectively,
a discharge device having a discharge element for discharging the delivered fluid out of the chamber,
the first injection element protrudes farther into the chamber than the second injection element and the first injection element protrudes farther into the chamber than the discharge element, and
a region at which the second injection element protrudes into the chamber is located higher than a region at which the discharge element protrudes into the chamber,
providing a capsule carrying a beverage component, the capsule having i) a body defining a cavity, the cavity having an opening at one side, and ii) a membrane attached to the body so as to cover the opening and close the cavity, the body including i) a beverage space containing a beverage component, ii) a head space extending between the beverage space and the membrane, and iii) a partition element separating the beverage space from the head space, the partition element,
receiving the capsule in the chamber,
inserting the first injection element through the membrane and into the beverage space,
inserting the second injection element through the membrane and into the head space,
inserting the discharge element through the membrane and into the head space,
delivering a fluid into the beverage space via the first injection element such that the delivered fluid, preferably the delivered liquid, may interact with the beverage component in order to prepare a beverage product,
discharging the beverage product out of the capsule via the discharge element, and
after having discharged the beverage product, injecting a fluid into the head space via the second injection element so as to rinse the discharge element.

12. Method according to claim 11, wherein, after having discharged the beverage product, the step of injecting a fluid into the head space via the second injection element comprises injecting a fluid into the head space via the second injection element so as to jet or spray the injected fluid on and/or around the discharge element, preferably at least on a discharge opening of the discharge element.

13. Method according to claim 11, further comprising:
injecting a gas into the head space via the second injection element during the delivery of fluid.

14. Method according to claim 11, wherein delivering fluid into the beverage space via the first injection element comprises, before producing the beverage product, pre-wetting the beverage component and evacuating gas from the capsule via at least one of the second injection element and the discharge element.

15. Method according to claim 11, further comprising:
injecting gas into the beverage space i) after injecting fluid into the beverage space and ii) at least partially simultaneously during discharging the beverage product and/or iii) at least partially during delivery of fluid.

16. Method according to claim 11, further comprising:
injecting gas into the head space via the second injection element after injecting fluid.
